(19) United States
(12) Patent Application Publication
(10) Pub. No.: US 2024/0195274 A1
(43) Pub. Date: Jun. 13, 2024

(54) Sector Roll Dipping Plant

(71) Applicant: Mr. Karl BAUCH, Kempten (DE)

(72) Inventors: Gerhard Karl MAIS, Limburg an der Lahn (DE); Karl BAUCH, Kempten (DE); Christoph MARTIN, Solms (DE); Sebastian BAUTZ, Weinbach (DE)

(73) Assignee: Karl BAUCH, Kempten (DE)

(21) Appl. No.: 18/555,019

(22) PCT Filed: Mar. 8, 2022
(86) PCT No.: PCT/EP2022/055918

§ 371 Date: Oct. 12, 2023

(30) Foreign Application Priority Data
Apr. 12, 2021 (DE) 10 2021 001 874.5

(51) Int. Cl. H02K 15/12; B05C 3/05; B05D 7/22

(52) U.S. Cl. CPC H02K 15/12; B05C 3/05; B05D 7/22

(57) ABSTRACT

A sector roll dipping plant for impregnating rotating components (1) of electric machines in the form of stators and rotors has a roll dipping tank or roller immersion tray (6) that is divided into sectors having impregnating agent inlets (11) which are separated from one another by bulkheads or partition walls (7). At least one sealing element (8) connected to one of the partition walls (7) is in contact with the rotating component (1). A method for impregnating a rotating component (1) (such as a stator or rotor of an electric machine) uses the sector roll dipping plant to cause only the grooves of the rotating component to be soaked with impregnating agent while laminations on the outer jacket surface of the rotating component remain clean.

### CROSS-REFERENCE TO RELATED APPLICATIONS

This application is a national stage application (under 35 USC § 371) of PCT/EP2022/055918, filed Mar. 8, 2022, which claims benefit of DE 102021001874.5, filed Apr. 12, 2021, the contents of each of which is incorporated by reference herein.

### BACKGROUND OF THE INVENTION

### Technical Field and State of the Art

The present invention shows a system and a method which can impregnate components, in particular stators and rotors of electric machines in the roll dipping process quickly, efficiently and with complete groove filling, without wetting the outer and/or inner diameter of the laminations.

A reliable heat-conducting fixation of the winding is particularly necessary for mobile electric drives with high accelerations, enormous power density and large temperature fluctuations. In these highly-stressed electric motors, uniform heat flow, excellent mechanical fixation of the winding and the best electrical insulation are required at every point of the winding. This is generally sought by introducing curing impregnating agents or paints. In doing so, only the winding and, if necessary, the grooves of the laminations should come into contact with the impregnating agent in order to prevent unnecessary impregnating agent consumption and not to obtain any unintentionally sticky surfaces or surfaces coated with impregnating agent, which then deviate from the specified tolerances. It is particularly difficult to see the complete filling of the laminated core grooves with impregnating agent, which are penetrated with flat wires or round wires. It is important to introduce impregnation quickly, economically, and in a resource-preserving manner.

To date, essentially two methods have been used. In a first basic method, the impregnating agent is applied and/or introduced during the rotation of the stators and rotors, hereinafter referred to as components. In a second basic method, the components are immersed in the impregnating agent. They are immersed for as long as it takes until the impregnating agent has gelled in the heated winding area or by building-up layers through repeated immersion, gelling and interim heating.

Immersion has the advantage of good groove filling and is known as a fast impregnation method. Disadvantages of this method are the contamination of the entire component by the adhesion of impregnating agent and the associated loss of dimensional stability, the increased consumption of impregnating agent and the environmental impact due to the discharge of the impregnating agent as well as the necessary re-cooling of the impregnating agent.

When applying the impregnating agent under rotation, i.e. drizzling, the contamination of the laminations is generally avoided, the impregnating agent consumption is limited to a minimum and the environmental impact is also greatly reduced. However, the duration of the impregnation process, the associated long gelling time and the inadequate filling of in particular long laminated cores with this method are problematic.

Roll submersion is a combination of both methods, which at the same time combine the advantages and disadvantages of both methods. Stators in electrical machines generally consist of an annular laminated core with grooves running along the inner diameter into which the winding is inserted. The winding heads protrude over the flat surfaces of the laminated core, which serve to deflect or connect the copper wires between the grooves. Currently, the winding wires are increasingly replaced by copper rods or flat wires. The rotor runs later in the center bore of the ring-shaped stator. In conventional roll submersion systems, the inner diameter of the stator is held by a clamping device. The slowly rotating stator is then immersed in a tray filled with a defined level of impregnating agent. The level is generally determined by overflow elements, in which more impregnating agent is always supplied than is accepted by the component. During roll submersion, the stator is only immersed in the impregnating agent bath to such an extent that the inner diameter remains unwetted and is therefore not contaminated. This also applies to the rotor if the rotor shaft is not yet installed. If it is already installed, it is only immersed to such an extent that the shaft does not come into contact with the impregnating agent. However, the disadvantage is that the outer diameter of the laminated core is wetted and contaminated with impregnating agent. In addition, the windings and the flat sides of the laminated core grooves are only partially immersed compared to the immersion, which leads to longer impregnation times and less well-filled laminated core grooves. Because the impregnating agent flows into the grooves in the component of both flat sides of the laminated core rotating horizontally in the impregnating agent bath, the enclosed air hinders the groove filling in its center space.

After being lifted out of the rolling submersion tray, the resin is stripped off and/or blown off on the outer diameter of the laminated core to the extent possible before it solidifies in the subsequent gelling and curing process.

Due to the fact that there can only be one medium in the immersion tray, the roll immersion method requires that the impregnating agent is already a reactive material, which is usually activated by temperature.

In the roll immersion method, previously customary, more impregnating agent is continuously fed to the immersion tray than the component is accepting. The excess impregnating agent flows back into the pump circuit via a filter and cooler. By immersing the entire outer surface of the generally preheated components, the impregnating agent heats up quickly and has to be cooled down in order not to react too quickly. The significant heat loss from the component by the impregnating agent is destructive, disrupts and slows down the impregnating process and destroys energy. In addition, the impregnating agent that has already been triggered with regard to chemical reactivity is repeatedly returned to the cycle, which makes an optimal and, in particular, reliable process difficult or even impossible over a long period of time. This prior art is exemplified in the documents EP 0 643 467 A2, DE 23 58 782 A1, DE 27 37 917 A1, DE 101 39 128 A1, PCT/JP 2013/084742, WO 03/013810 A1 and WO 2017/042013 A1.

The published patent DE 36 31 980 A1 presents a method for the impregnation of windings of electric machines, wherein the electric machine parts are rotated along a longitudinal axis aligned diagonally to the horizontal axis and then partially immersed in a resin immersion bath in a horizontal position for rolling submersion, wherein the winding heads are additionally sprayed. The outer skin of the laminated core is contaminated with resin.

Publication JP H10-271 775 A describes an impregnation method for rotors of electric machines, wherein the impregnating agent is applied in different inclined positions of the rotating rotor in order to achieve better penetration into the grooves with coils.

Publication JP H08-317616A presents a method and a device for roll immersion impregnation of the grooves in laminated cores for stators. This allows the commonly used inserted groove insulation of the laminated cores to be replaced. In order for the air to escape better from the grooves, the laminated core is placed at an angle into the impregnating agent bath. The laminated core is contaminated with resin both inside and outside. In addition, no level difference is shown along the stator.

EP 0 321 223 A2 shows a system in which the rotor grooves are also insulated by means of roll immersion before the copper windings are drawn in. The immersion tray with the insulation medium is hereby in a horizontal position.

JP 2005-285 933 A presents an immersion method in which components with windings are placed in an ultrasonic immersion bath in order to fill the cavities between the winding and the laminated core faster and better with resin.

The outer skin of the laminated core is contaminated with the impregnating agent in all of these immersion methods presented.

In addition, document WO2019/211461 A1 presents a method, wherein the impregnating agent is introduced into the laminated core grooves by means of a carrier medium. This method is currently still very expensive and it is difficult or has not yet been feasible, if the gaps between the flat wire windings and in particular the hair pin stators are small.

In all roll submersion systems previously in use and presented in the documents, stators with a central axial bore for the rotor are immersed so far in horizontally positioned roller immersion trays with impregnating agent bath that the resin can enter the grooves of the laminated core and encloses the winding parts and the resin level does not reach or wet the inner diameter of the stator. In the case of deeper immersion, the inner diameter of the laminated core is also contaminated with resin.

The stator rotates slowly in the resin bath so that the resin can flow and/or diffuse through all grooves on the circumference through which windings are passed. Not only is the winding impregnated with resin, but the outer diameter and the flat surfaces of the laminated core are also contaminated with resin. The resin on the laminated core is usually disadvantageous because it causes problems when shrinking into the housing or when sealing the stator due to lack of strength and dimensional stability. The resin adhering to the outer skin of the laminated core is removed by scraping and/or blowing off, if this is subsequently possible. This necessitates additional work steps and significantly increases the emission of resin vapors.

The new solution is therefore based on the task of proposing a system and a method that enables complete groove filling, short cycle times and clean laminated core, as well as minimal impregnating agent consumption when impregnating round wire and flat wire windings on electric machines.

### SUMMARY OF THE INVENTION

The presented sector roll submersion system is a new embodiment of a roll submersion system, in particular for the introduction of impregnating agents such as resins into the cavities between the laminated core grooves and the windings on the winding heads. The impregnation serves for additional insulation, better heat transfer and mechanical fixation of the copper parts designated as windings.

The special features of the sector roll submersion system are the immersion tray divided into sectors and the sealing elements inserted between the component and the immersion tray or the partition walls. The partition walls limit or define the sectors within the submersion tray. The sealing elements help to ensure that the resin level present in individual sectors only rests on the component up to the points where the sealing elements connected to the partition walls are resting.

The roll submersion tray divided into sectors enables different resin levels in the different sectors. They also allow areas of a roll submersion tray filled with an impregnating agent to be placed next to one another. Thus, this makes it for the first time possible to tilt a roll submersion tray filled with liquid medium and thereby generate different fluid levels within a roll submersion tray.

The sector roll submersion system is characterized by the fact that for the first time the roll submersion of inclined components is possible and also, both with inclined and horizontal component positions, lateral surfaces with the largest outer diameter can remain free of the impregnating agent. By tilting the components, in addition to the capillary effect, the gravitational force can also be used to fill the laminated core grooves through which the winding passes. By filling the grooves with the impregnating agent on one side, it is possible to avoid trapping air in the middle area of the grooves during roll immersion.

The sector roll submersion system is characterized by a roll submersion tray that is divided into sectors in order to realize different levels of impregnating agent depending on the component region. It is thus possible, for example, to rotate the winding heads of a stator in the impregnating agent bath without wetting and contaminating the outer skin of the laminated core, which is larger or of equal size in diameter. The partition walls between the sectors of the immersion tray preferably comprise sealing elements in the contact area with the component. Alternatively, the partition walls themselves are configured as a flexible sealing element, which optionally already has the contour of the component at the point to be sealed, or adapts to its contour.

The roll immersion tray of the presented system is either connected to the pivoting unit of the component transport unit and is inclined together with the component, or it has a separate drive that allows independent or synchronous pivoting angles and linear movements to be performed relative to the component. The partition walls in the roll immersion tray are fixedly positioned or manually and/or movably mounted in a motorized manner depending on the requirement. The sectors can thus be adapted to different components and, if necessary, the partition walls with the sealing elements can be moved against the sealing surfaces of components and pressed on with varying degrees of force. Both the partition walls and the sealing elements are interchangeable.

In order to prevent the backflow of the impregnating agent, which has already been triggered in its chemical reaction by heating on the component, into the circuit and to ensure a permanently reliable process, it is proposed that the roll immersion tray be adapted to the contour of the component. Thus, there is only a small amount of impregnating agent in the tray, which, on the one hand, shortens the retention time in the tray during normal subsequent production and, on the other hand, significantly improves the ratio of heated impregnating agent in the roll immersion tray to the cool freshly supplied impregnating agent. Due to the fact that only the surfaces to be impregnated come into contact with the impregnating agent, significantly less heat is transferred from the component to the impregnating agent. Therefore, for this reason, the impregnating agent needs no longer to be returned; a cooled immersion tray is already sufficient to dissipate excess heat. A shape of the roll immersion tray adapted to the component and the associated new method ensures timely processing of the once heated and thus activated impregnating agent.

If the component is brought in and out in a horizontal position and if both are tilted together in an inclined position for the sector roll submersion, a specially designed immersion tray is recommended. An immersion tray designed for the inclined insert preferably has at least one reservoir for the impregnating agent. In the immersion tray in an inclined working position, this impregnating agent reservoir has the function of emptying at least to such an extent that the sector to be filled with the impregnating agent reaches the desired level. In the horizontal parking position, the impregnating agent reservoir then fulfills the task of receiving the impregnating agent from the impregnation sector, or of temporarily storing it until it is needed again.

The impregnating agent, which flows over a partition wall not provided with a sealing element and thus defines the level, enters separate impregnating agent reservoirs or buffers and is supplied to the next component.

The partition walls serve to keep the impregnating agent away from the parts of the component that are not to be impregnated and thus significantly reduce the consumption of the impregnating agent, to prevent heat dissipation caused by the impregnating agent at these points and to avoid contamination of the components at these dimensionally sensitive points. The partition walls are therefore provided with sealing elements that can be adjusted in particular to the component contour. Alternatively, the partition walls themselves are configured as flexible sealing elements, e. g. made of rubber. It is recommended that these be made adjustable to the component contour. In the case of contour-adjustable sealing elements and/or partition walls, the impregnating agent remains in the impregnating sector with the last impregnating agent contained therein. By immersing the component, the level of the impregnating agent rises while the sealing elements lower under contact with the component contour. The maximum level is defined by the height-adjustable partition walls. Alternatively, it is recommended that the level be controlled by the impregnating agent flow rate in relation to the impregnating agent acceptance quantity of the component. Thus, exactly as much impregnating agent is supplied as is to be accepted by the component or as is to be accepted. This method allows a small amount of component-specific compensation of the impregnating agent's volume. The volume of the impregnating agent that was accepted is additionally preferably determined by weighing the component before and after impregnation.

If the sealing elements and/or the partition walls are designed in such a way that they already have the contour of the area of the component to be sealed, the impregnating agent is returned at least partially to an impregnating agent reservoir or an impregnating buffer prior to removing the component from the tray in order to prevent the impregnating agent from overflowing over the sealing element contour. After positioning the new component in the immersion tray and the associated sealing, the impregnating agent is returned to the immersion section. During impregnation, only the volume of impregnating agent currently accepted by the component is then preferably supplied. This makes it possible for the first time to realize a roll submersion impregnation solution without overflow. If the impregnating agent cannot flow back into an impregnating agent reservoir due to the roll immersion tray design or the applied method because the roll immersion tray is not pivoted, for example, reservoirs are used as hydraulically connected cylinders as far as possible for the temporary absorption of the impregnating agent from the individual sectors. Once the impregnation has been completed, the cylinder suctions the impregnating agent at least largely via the bottom opening before removing the component and quickly conveys it to the corresponding sector of the roll immersion tray after positioning the new component. The volumes and thus the level remain the same. Only the amount of impregnating agent that is accepted or may be accepted by the component in the respective sector at the corresponding time is then supplied. By means of a rolling immersion tray in a contour similar to the component, the amount of impregnating agent stored in the respective segment can be significantly reduced, so that the once supplied and heated impregnating agent remains only briefly in the rolling immersion tray. In order to protect the impregnating agent from excessive heating caused by the generally preheated components, the large proportion of freshly supplied cooled impregnating agent on the one hand and, on the other hand, a cooled rolling immersion tray and possibly cooled impregnating agent-receiving cylinders.

To simplify production, it is suggested to assemble the roll immersion tray from several trays or tubs. For ease of handling and more flexible use, it makes sense not to connect the individual trays tightly to one another. Actuators between the trays enable their variable positioning relative to each other and thus automatic adjustment for components with different dimensions and contours.

The automatic adjustment of the roll immersion tray with partition walls to different components is also possible using partition walls and sealing elements that can be moved with actuators.

In addition to the feeding of the components to the roll immersion tray and the subsequent impregnation shown in the figures of this application, it is suggested that this be done using robots. For this purpose, a spindle with a gripper is attached to the robot arm. The gripper can either grip the component directly or a component carrier. For example, the robot removes the component from the preheating oven, fees it to the roll immersion tray, positions it in the impregnation position with the desired inclination against the sealing elements and sets it in slow rotation at the specified speed. By subsequently increasing the resin level to the desired level, the resin penetrates between the copper wires and the gaps between the grooves of the laminated core, the insulating paper and the copper wires. Once the resin has filled all the cavities, the resin level in the roll immersion tray is quickly lowered and the component is fed to the gelling oven with faster rotation to gel the liquid resin.

The sector roll submersion system is optionally equipped with a vacuum chamber, which allows impregnation with largely no air. The vacuum chamber optionally encloses only the component with the rolling immersion tray or the entire rolling submersion station. If the vacuum-tight housing of the component and immersion bath is optional, the impregnating agent is prepared under vacuum before use, i.e. degassed and dehumidified. To ensure that the impregnating agent does not come into contact with the humid ambient air when the component is being removed and inserted, a vacuum-tight impregnating agent reservoir is provided for the impregnating agent. The impregnating agent is then brought to the impregnating agent reservoir before ventilation and pushed back into the immersion sector after vacuuming. In this case, a cylinder is preferably used as an impregnating agent reservoir. In order for the vacuumed space to be as small as possible and the energy requirement is low, it is proposed to design the immersion tray as a lower part of a horizontally divided vacuum chamber. Only the component carrier to be sealed protrudes into the vacuum chamber, the shaft of which is enclosed by the two chamber halves. The vertical axis of the immersion tray or the lower vacuum chamber half thus simultaneously serves to open the chamber and to adjust the immersion depth for the component in the impregnating agent. By vacuum-sealing the component and in particular the cavities in the component to be filled with impregnating agent, they can be filled with impregnating agent more quickly and comprehensively.

By means of vibrations, in particular high-frequency vibrations in the ultrasonic range which act on the impregnating agent and/or the component, the fill level and the wetting of the cavities around the winding are improved, as a result of which the impregnation time is further reduced. Depending on the medium and the component, frequencies from 20 Hz to 20 MHz are used for this purpose.

Additional objectives, advantages, features and application possibilities of the present invention can be gleaned from the description below of embodiments making reference to the drawings. In this context, all of the described and/or depicted features, either on their own or in any meaningful combination, constitute the subject matter of the present invention, also irrespective of their compilation in the claims or in the claims to which they refer.

### DESCRIPTION OF THE DRAWINGS

FIG. 1 shows a lateral view of an example of a pivoting sector roll submersion system,

FIG. 2 shows an inclined rolling immersion tray 6 in the section with the component 1 in a side view in an inclined impregnation position,

FIG. 3 shows the rolling immersion tray 6 in the section with the component 1 in the side view when the component 1 and the impregnating agent 12 are brought into and out of the impregnating agent reservoir 9 and

FIG. 4 shows the exemplary embodiment of a rolling immersion tray 6 with the sectors for different functions in a top view.

### DETAILED DESCRIPTION

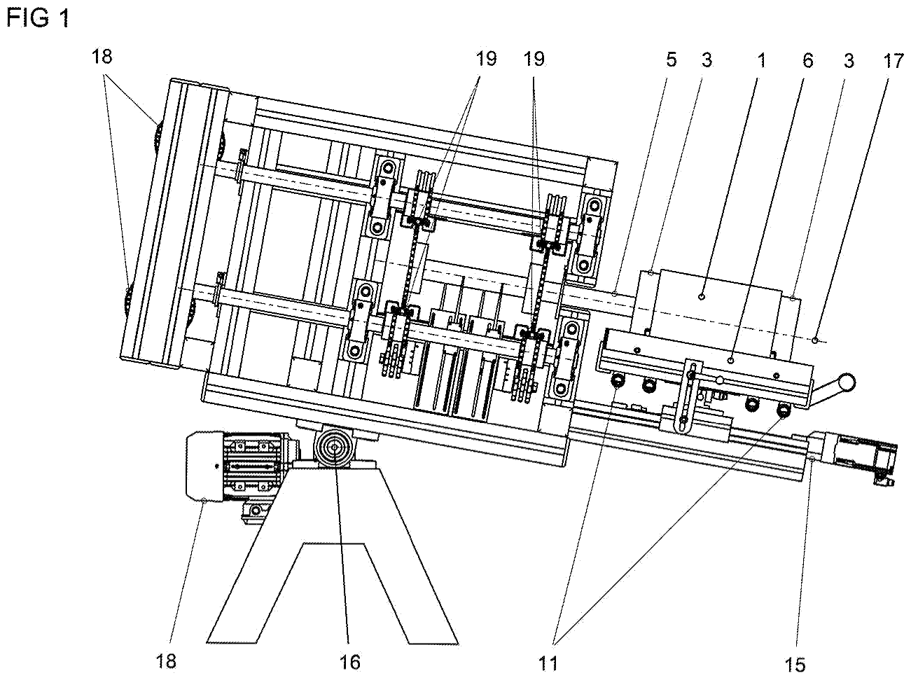

According to FIG. 1, the sector roll submersion system serves for the rolling immersion impregnation of the windings 2 of the components 1 of electric machines, in particular of stators and rotors. During the impregnation process, the component 1 rotates supported by a component carrier 5, in a position of the sector roll submersion system predefined by a program and in particular the rolling immersion tray 6. The position-fixed rotational drive of the component 1 about the axis of rotation 17 is realized by opposing pairs of chains in the transport device 19, which act on the chain wheels fixed on the component carrier 5.

The roll immersion tray 6 of the present system is either connected to the pivoting unit of the transport device 19 fixed on the pivot axis 16 and is inclined together with the component 1, or has a separate drive, which allows the angle of inclination of the component 1 to be followed independently or synchronously and to perform linear movements relative to the component 1 by means of at least one linear axis 15. The linear axes 15, the pivot axis 16, and the translational and rotational movement of the component 1 about the axis of rotation 17 are driven by the actuators 18. The partition walls 7 in the roll immersion tray 6 are fixedly positioned or manually and/or movably mounted in a motorized manner depending on the requirement. The sectors can thus be adapted to different components 1 and, if necessary, the partition walls 7 with the sealing elements 8 can be moved against the sealing surfaces of components 1 and pressed on with varying degrees of force. Both the partition walls 7 and the sealing elements 8 are interchangeable.

The component carrier 5 has an integrated clamping device, which allows centered fixing of different components 1 with respect to the component carrier 5. The component carrier 5 with the integrated clamping device allows the exchange of the components 1 at predefined locations and the safe transport of the rotating components 1 through the entire system. The translational movement of the component 1 with simultaneous rotation occurs through different speeds and/or directions of movement of the chains of the transport device 19 which are driven by shafts and sprockets. The sprockets of the component carrier 5 in turn engage the chains driven by actuators 18.

The component 1, in particular the stator, essentially consists of a laminated core and the winding 2, which may also comprise round wires or flat wires or hairpins. The winding 2 is located in the stator in the inner laminated core grooves 4. The deflection and connection of the wires or hairpins outside of the laminated core designated as winding 2 are called winding heads 3.

In order for only the winding heads 3 and the winding 2 inserted into the laminated core grooves 4 to come into contact with the impregnating agent 12, while the contour of the laminated core remains as free as possible from the impregnating agent 12, the rolling immersion tray 6 is specially shaped. As indicated in the illustration, this project is achieved by partition walls 7, which are located in the rolling immersion tray 6 and are equipped with sealing elements 8, or are at least partially constructed from sealing elements 8. In the last case, the partition walls 7 preferably consist of elastomers that adapt to the contour of the component 1 and act simultaneously as sealing elements 8. This rolling immersion tray design, makes it is possible to realize different impregnating agent levels in adjacent sectors of the rolling immersion tray 6 and thus determine which parts of a component 1 come into contact with the impregnating agent 12. For example, for the winding heads 3 of stators immersion sectors 13 are defined in the rolling immersion tray 6 and these are filled with impregnating agent 12 via impregnating agent inlets 11.

The sector in which the non-impregnable laminated core is located remains empty. The impregnating agent 12 can thus only reach the winding heads 3 and into the laminated core grooves 4, provided that the stator is immersed at most up to the lower edge of the inner diameter. By slow rotation, the winding heads 3 and the laminated core grooves 4 are filled all around, while the laminated core remains clean on the inner and outer diameter.

For rotors, in particular closed rotors with an outer casing, the sealing takes place on the flat surfaces, so that the impregnating agent 12 can only enter and exit on the flat surfaces and only the annular surfaces on the flat sides are wetted.

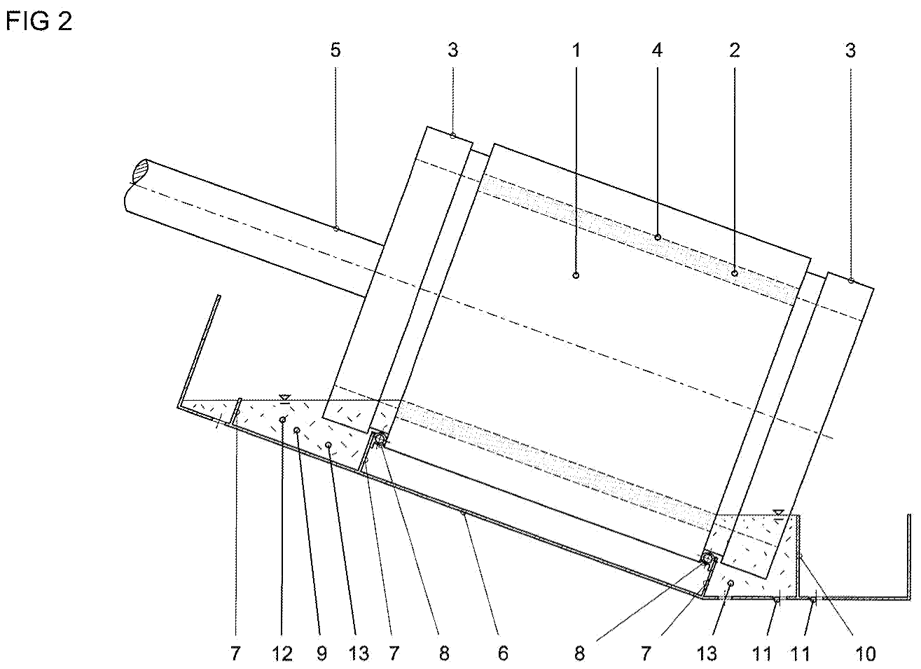

FIG. 2 shows an exemplary rolling immersion tray 6 with partition walls 7 and sealing elements 8 fastened thereto for rolling submersion impregnation shown in an inclined position in a cross-section, while the stator clamped on the component carrier 5 can be seen uncut in the side view in the impregnation position. The sectors separated by the partition walls 7 can be seen. The individual sectors are provided with impregnating agent openings 11 that serve both the inlet and the outlet of the impregnating agent 12. One part of the partition walls 7 is without the sealing element 8 and thus lower than the partition walls 7 with integrated or attached sealing elements 8. They serve as an impregnating agent overflow 10 and thus ensure a level limitation. This allows for a uniform level of the impregnating agent and thus a reliable immersion depth, fast and repeatable. The overflowing impregnating agent 12 is either returned to the original sector by pivoting the rolling immersion tray 6 or collected in a separate sector and primarily fed to the impregnating agent supply.

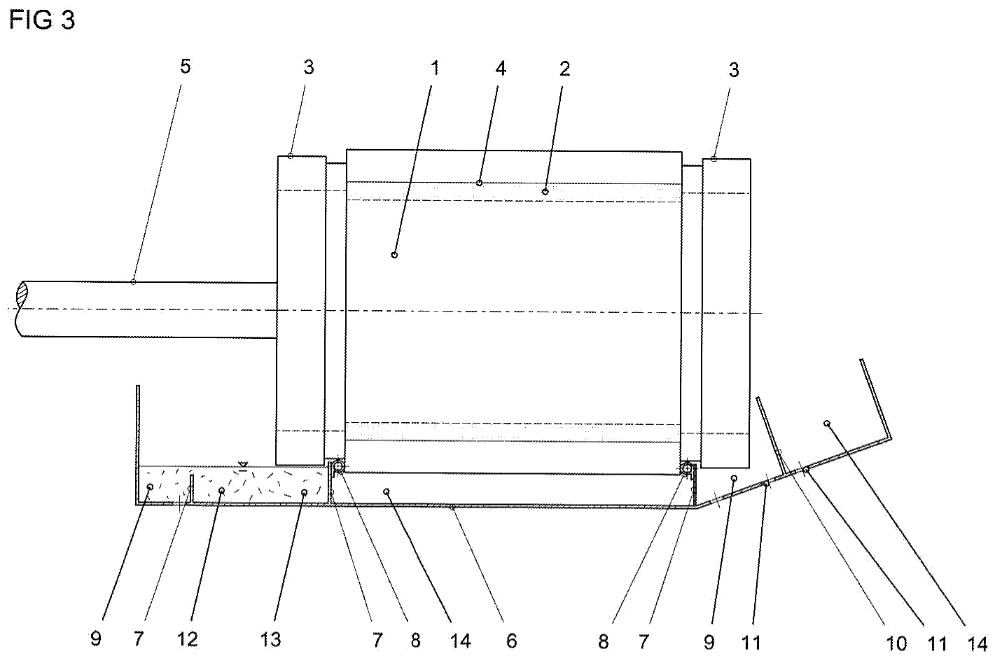

In the embodiment shown, the higher immersion sector 13 of the rolling immersion tray 6 also functions as an impregnating agent reservoir 9 as soon as the rolling immersion tray 6 is brought into the horizontal plane. By pivoting the rolling immersion tray 6 horizontally, as shown in FIG. 3, the impregnating agent 12 flows back into the lower area, as a result of which the impregnating agent level in the area of the component 1 lowers below the lowest point of the sealing element 8 or the partition wall 7. When the component 1 is removed, no impregnating agent 12 flows over the sealing element 8; the previously existing level is immediately reached when the new component 1 is pivoted inwards without the supply and removal of the impregnating agent 12. The supply and optionally also the removal of the impregnating agent 12 takes place via the impregnating agent openings 11. The level of the impregnating agent 12 is also limited by impregnating agent overflows 10. The overflowing impregnating agent 12 is collected in the overflow sectors 14 as shown in FIG. 3 and, if necessary, discharged. This ensures on the one hand that the level of impregnating agent does not rise above the lower edge of the inner diameter and thus contaminates the interior of the stator and, on the other hand, that the sector in which the laminated core is located remains free of the impregnating agent 12.

The immersion depth of the component 1 into the impregnating agent 12 is defined by the freely programmable position of the component 1 in relation to the rolling immersion tray 6. The rolling immersion trey embodiment shown in FIG. 2 is designed in the immersion area with the partition walls 7 and the sealing elements 8, which are adapted to the component contour. The illustrated round sealing elements 8 are preferably designed as sealing lips, so that no residue of the impregnating agent 12 overflows when the component 1 is lifted off. Due to the axial mobility of the rolling immersion tray 6 and a rolling immersion tray inclination independent of the component inclination, the insertion of the component 1 between the seals can thus be managed even if the partition walls 7 and the sealing elements 8 attached thereto are not displaceably mounted in the rolling immersion tray 6.

The impregnation of an inclined component 1, in particular a stator, can also be realized in the proposed manner with only one sealing element 8 by not only impregnating the laminated core grooves 4 with the winding 2 located therein from the upper immersion sector 13, but also the opposite winding head 3 through the laminated core grooves. In the illustrated version of the rolling immersion tray 6, the lower submersible sector 13 can also be filled with the impregnating agent 12 via the impregnating agent openings 11, which simultaneously makes it possible to impregnate the deeper-lying winding head 3.

FIG. 3 shows the dual function of the impregnating agent reservoir 9, which is also an immersion sector 13. In the horizontal position, the level of the impregnating agent 12 sinks to such an extent that no impregnating agent 12 flows off over the sealing element 8 when the component 1 is removed.

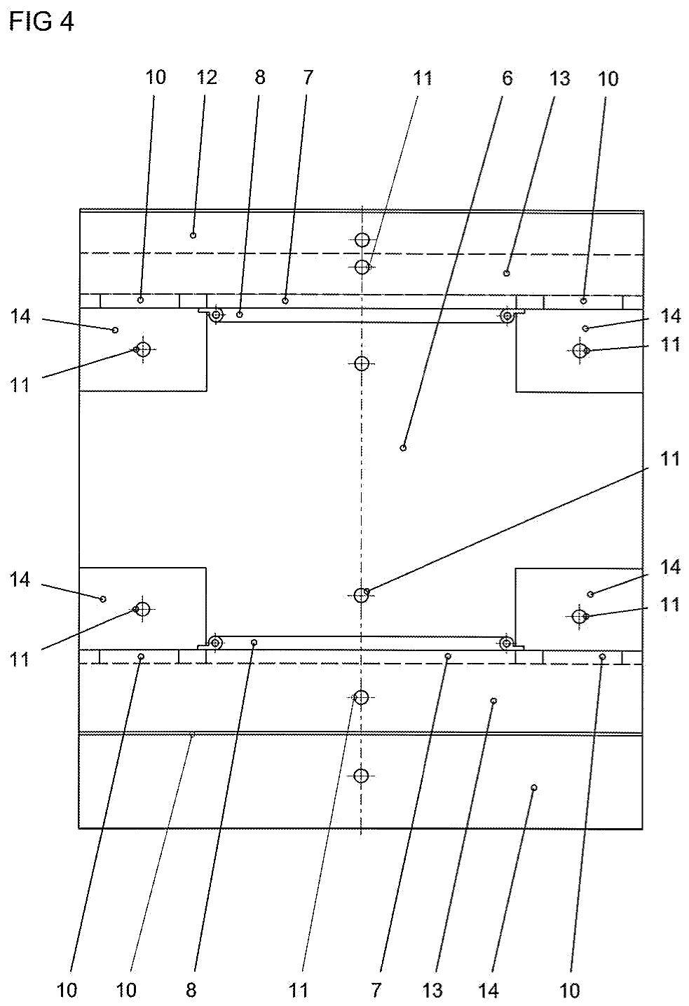

The rolling immersion tray 6 shown by way of an example in FIG. 4 includes the partition walls 7, which seal against the tray and are mounted in different positions depending on the component dimensions. The partition walls 7 are interchangeable so that their heights and shapes can vary. In an optionally proposed embodiment, they are mounted so that they can be moved continuously and can be positioned manually or automatically by means of linear drives. The maximum level of the impregnating agent in the tank is defined by the height of the partition wall 7 itself or by height-adjustable elements. These sliding elements, or if they are not present, the partition walls 7 without sealing element 8 may serve as needed as an impregnating agent overflow 10. The impregnating agent 12 that overflows is preferably collected in overflow sectors 14 and fed to the impregnating agent inlet. If there are no special overflow sectors 14, the adjacent sectors not overflown with impregnating agent 12 with their impregnating agent inlets 11 serve as such. The center area of the partition walls 7 is designed as an arc to the component contour at the sealing point. The sealing elements 8 follow the arc contour and are connected to the partition wall 7 in a sealing but exchangeable manner. The ends of the sealing elements 8 consisting of polymers or metals are formed outwards in order to capture the impregnating agent 12 that drains outwards in individual cases on the flat surface.

### LIST OF REFERENCE NUMERALS

1 Component
2 Winding
3 Winding head
4 Laminated core with groove
5 Component carriers Rolling/
6 Roller immersion tray
7 Partition wall
8 Sealing element
9 Impregnating agent reservoir
10 Impregnating agent overflow
11 Impregnating agent T-junction
12 Impregnating agent
13 Immersion sector
14 Overflow sector
15 Linear axis
16 Pivoting axis
17 Rotational axis
18 Actuators
19 Transport unit

1. A sector roll dipping plant apparatus for impregnating a rotating component (1) such as a stator comprising a laminated core (4) and a current-carrying winding (2), a winding head (3), or a rotor comprising a laminated core (4) and a winding (2) of an electrical machine, comprising:
a roller immersion tray (6) that is divided into two or more sectors with impregnating agent openings (11), which are separated from one another by one or more partition walls (7), wherein at least one sector is filled with impregnating agent (12) to a desired filling level and at least one adjacent sector is unfilled with impregnating agent, and wherein the roller immersion tray (6) in at least one sector defines impregnating agent openings (11) configured to pass impregnating agent (12) into and out of the at least one of the sectors of the roller immersion tray (6) that is filled with impregnating agent (12), and at least one sealing element (8) that is connected to or formed on at least a respective one partition wall (7) and that is in contact with the outside of the laminated core (4) of the rotating component (1), so that with at least a Portion of the outside diameter of the laminated core (4) of the rotating component (1) is positioned in the unfilled sector of the roller immersion tray (6), impregnating agent (12) in the filled sector of the roller immersion tray (6) flows into the winding (2), winding head (3) and existing grooves of the laminated core (4) of the rotating component (1) without contacting lateral surfaces of the rotating component (1) designated to remain free of impregnating agent (12).

2. The sector roll dipping plant apparatus according to claim 1, wherein individual partition walls (7) of the one or more partition walls are designed at least partially as an elastic sealing element (8).

3. The sector roll dipping plant apparatus according to claim 1, further comprising: wherein the rotating component (1) and/or the roller immersion tray (6) are mounted in a vertically pivotable manner, and wherein respective pivot axes are connected to a controlled drive, and wherein the rotating component (1) is connected to a transport unit (19) and a drive (18) for component rotation via a component carrier (5).

4. The sector roll dipping plant apparatus according to claim 1, wherein the rolling submersion tub (6) follows the contour of the rotating component (1) at least in sections at a distance of 2 to 50 mm, and the sealing elements (8) are deformable and are mounted spring-loaded at their connections, or are configured as expansion elements.

5. The sector roll dipping plant apparatus according to claim 1, wherein the roller immersion tray (6) is mounted in a vertically pivotable manner, and the roller immersion tray sectors have floors and/or impregnating agent reservoirs (9) which are inclined in the pivoting direction.

6. The sector roll dipping plant apparatus according to claim 1, wherein the rotating component (1) and/or the impregnating agent (12) are physically connected to a vibration generator.

7. The sector roll dipping plant apparatus according to claim 1, wherein the roller immersion tray (6) and/or the rotating component (1) are at least partially located in a vacuum enclosure.

8. The sector roll dipping plant apparatus according to claim 1, wherein the partition walls (7) comprise the sealing elements (8) and are elastically deformable to adapt to the rotating component (1) contour.

9. The sector roll dipping plant apparatus according to claim 1, wherein one or more of the sectors of the roller immersion tray (6) that carry impregnating agent (12) are connected to a cooling unit and/or heating unit.

10. A method for impregnating rotating components (1) of electrical machines such as a stator comprising a laminated core (4) and a current-carrying winding (2), a winding head (3), or a rotor comprising a laminated core (4) and a winding (2) of the electrical machine, comprising:
placing the rotating component (1) into a roller immersion tray (6), wherein the roller immersion tray (6) is divided into two or more sectors which are separated from one another by one or more partition walls (7), wherein at least two sectors are fillable with impregnating agent (12) each to a respective desired filling level and at least one adjacent sector is unfilled with impregnating agent, and wherein at least one sealing element (8) is connected to at least a respective one partition wall (7),
with the rotating component (1) having an inner diameter and an outer diameter and the laminated core (4), said laminated core (4) defining grooves therein, and having windings (2), winding heads (3) and flat sides of the laminated core grooves (4), and
with the rotating component (1) being placed so that one or more of the winding heads (3) and one or more of the flat sides of the laminated core grooves (4) are located in the respective sectors filled with the impregnating agent (12); and
rotating the rotating component (1) in the roller immersion tray (6), so that the winding heads (3) and flat sides of the laminated core grooves (4) come into circumferential contact with the impregnating agent (12), and the inner diameter and outer diameter of the laminated core remain free of contact with the impregnating agent.

11. The method according to claim 10, wherein: the rotating component (1) is held variably in a horizontal position or at one or more angles of inclination of an axis of rotation (17), and wherein the roller immersion tray (6) is pivoted together with the rotating component (1), or has a defined angle of inclination, to which the rotating component (1) pivots for impregnation.

12. The method according to claim 10, wherein the two winding heads (3) and the laminated core grooves (4) are impregnated in at least three successive or simultaneous impregnation steps, and wherein the rotating component (1) is inclined at an angle so that the lower winding head (3) is flooded or drizzled with impregnating agent (12).

13. The method according to claim 10, wherein the rotating component (1) is a radially open rotor and the winding (2) is impregnated by filling a central sector with impregnating agent (12) in the roller immersion tray (6) and rotating the winding (2) therein, and wherein the impregnating agent (12) is kept away from adjacent faceplates and housing parts of the radially open rotor by the sealing elements (8) and the partition walls (7).

14. The method according to claim 10, wherein the rotating component (1) is a closed rotor with openings in flat sides thereof, and the winding (2) is impregnated by filling two separate sectors with the impregnating agent (12) in the roller immersion tray (6) and placing the rotating component (1) windings (2) in the two separate sectors and rotating so that the impregnating agent (12) contacts the openings in the windings (2), and wherein the rotating component (1) is inclined toward the end of the impregnation process in order to discharge any excess impregnating agent (12).

15. The method according to claim 10, wherein the roller immersion tray (6), has an integrated impregnation reservoir (9) which is vertically pivotable in relation to the axis of rotation (17) of the rotating component (1), and wherein the roller immersion tray (6) transfers the impregnating agent (12) from the impregnating agent reservoir (9) by vertically pivoting to at least one impregnating sector of the roller immersion tray (6), and wherein the impregnating agent (12) flows back into the impregnating agent reservoir (9) by pivoting the roller immersion tray (6) back horizontally, so that the impregnating agent (12) does not have to be supplied and discharged with each new rotating component (1) to be impregnated in the roller immersion tray (6) and may be directed to different sectors of the roller immersion tray.

16. The method according to claim 10, further comprising: heating the roller immersion tray (6) and maintaining retention time of the impregnating agent (12) in the roller immersion tray (6) low by reducing contact surface of the sectors and exposure time of the impregnating agent (12) in the sectors of the roller immersion tray (6).

17. The method according to claim 10, further comprising: removing the impregnating agent (12) from the sectors of the roller immersion tray (6) before the rotating component (1) is removed from the roller immersion tray (6), and storing the removed impregnating agent (12) in one or more reservoirs; and returning the removed impregnating agent (12) from the reservoir(s) to the roller immersion tray (6) after placing a second rotating component (1) in the roller immersion tray (6), wherein subsequent supply of the impregnating agent (12) to a next respective sector corresponds exactly to the volume, which the second rotating component (1) receives or is to receive at the current time and in the respective sector.

18. The sector roll dipping plant apparatus according to claim 8, wherein the sealing elements (8) comprise polymers and/or spring plates.

19. The sector roll dipping plant apparatus of claim 1, wherein the partition walls (7) are of respective heights to maintain filling levels of impregnating agent (12) in the sectors so that only desired surfaces of the rotating component (1) are contacted by impregnating agent (12).

20. The method of claim 10, wherein the impregnating agent (12) is supplied at different filling levels in two of the sectors of the roller immersion tray (6).

21. The sector roll dipping plant apparatus of claim 1, wherein the roller immersion tray (6) comprising several sectors is formed from several individual trays, wherein there can be gaps, and actuators between the individual trays enable their variable positioning relative to each other to accommodate automatic adjustment for rotating components with different dimensions and contours.

22. the sector roll dipping plant apparatus of claim 1, wherein the rotating component (1) via a component carrier (5) is transported by a robot to the roller immersion tray (6), brought by the robot into the desired impregnation positions at the roller immersion tray (6), and rotates the rotating component (1) using a spindle mounted on the robot.
